(19) United States
(12) Patent Application Publication
(10) Pub. No.: US 2010/0102534 A1
(43) Pub. Date: Apr. 29, 2010

(54) FOOT/LEG CAST SUPPORT for STROLLER

(76) Inventor: Benjamin Kline Hunnicutt, JR., New York, NY (US)

Correspondence Address: Benjamin K. Hunnicutt Jr, 370 Riverside Dr # 11E, New York, NY, 10025, US

(21) Appl. No.: 12/256,695

(22) Filed: Oct. 23, 2008

(51) Int. Cl. B62B 9/12

(52) U.S. Cl. 280/643

(57) ABSTRACT

An adjustable support mechanism for supporting foot (feet), leg(s) in casts or braces of various sorts that attaches to a stroller is provided. The adjustable support comprises two shelves connected to adjustable joints. The support is adjustable to the angle of the seat of the stroller and attaches securely to the frame of a stroller. The support is usable with different types of strollers.

### BACKGROUND

1. Field of the Invention

This invention relates to commercial strollers and particularly to devices used for aiding children with foot or leg casts or braces of various sorts. More specifically, relates to an orthopedic device detachable from a commercial stroller to support the foot, feet, leg or legs of a child casted in a predetermined position. Allowing the handler of the child a maximum of ease in transportation the child throughout a typical day, providing the child with support and comfort while confined in a cast over a period of time.

2. Description of Prior Art

Devices used for transporting a child while supporting a child's foot, feet, leg or legs fixed in a predetermined position have been around for many years. They include the common wheelbarrow, a child's red wagon, and specially designed wheelchairs or seats available from boutique orthopedic suppliers. Commercial strollers are used internationally. Different types of attachments have been made to increase the convenience and comfort of both the child in the stroller and the person caring for the child.

This invention is a tremendous step forward in the development of devices used for transporting an injured or disabled child, while increasing comfort and convenience of the child and caretaker.

Some babies are born with development hip problems, a club foot or at some point in their young lives a child may injure their foot, leg or hip. These injuries may result in one foot in a cast or one or both legs in either a leg cast or a spica cast.

A leg cast begins at the top or at the knee of a leg and continues over the foot of that leg. Sometimes the leg or foot must remain elevated to aid in the recovery process. A spica cast begins at the waist or chest and continues to above the knees, or begins at the waist or chest and continues over the foot on one leg and above the knee on the other leg. The cast positions the child's legs outwardly from the trunk, such that a child may only lie on its back, front or side with the support of strategically placed pillows or supports. A spica cast is provided with an opening whereby the child may relieve itself. The opening is covered with a diaper.

An infant with a cast as described above is relatively easy for one person to manage. A toddler or child, however, confined to these types of casts is difficult for one person to manage. The weight of the child is increased by the addition of the cast and the child cannot roll over without assistance. The child cannot be conveniently maneuvered from place-to place because the leg or foot in the cast extends beyond, outside or cannot be supported by conventional stroller leg or foot rests. The child in a foot, leg or spica cast cannot be managed in regular commercially available strollers.

There are existing devices that go beyond the standard stroller:

The orthopedic device in U.S. Pat. No. 3,563,601 to Dickey, October 1968 is desired when a child is in a Spica cast or Frejka pillow splint.

There are existing devices that attach to a stroller:

The footrests in U.S. Pat. No. 6,367,879 to Er-Jui Chen, Chuan-Tao Tai, Chih-Jung Chang, August 2000 and U.S. Pat. No. 5,660,435 to Eichhorn, August 1997 is desired when a child is able to sit with legs bent and foot resting on the footrest of the stroller.

The footrest in U.S. Pat. No. 5,772,235 to Gregg R. Espenshade Assigned to Graco's Children's Products, November 1995 is desired when a child is ambulatory and is able to sit with legs extended and resting on the footrest of the stroller.

The seat extension in U.S. Pat. No. 4,741,056 to Kenzou Kassai Assigned to Aprica Kassai Kabushikikaisha, April 1987 is desired when a child is ambulatory and is able to sit with legs extended and resting on the seat extension of a baby carriage.

It is the expansion of these and other uses to which the present invention is directed, along with the inclusion therein of other novel and desirable features.

### OBJECTS AND ADVANTAGES

Besides the objects and advantages of the detachable support described in my above patent, several objects and advantages of the present invention are:
1. To provide an orthopedic device of simple construction and operation.
2. To provide a new and novel orthopedic device for aiding in the transportation of a child confined in a foot, leg or spica cast, providing the child with maximum comfort and providing parents and caretakers with maximum ease in handling the child throughout a typical day.
3. To provide a device that can be used temporarily, with common strollers.
4. To provide a stable support for a foot or leg(s) in a cast while a child is in a stroller.

These and other objects and advantages will become apparent from a consideration of the ensuing description and drawings.

### SUMMARY OF INVENTION

### BRIEF DESCRIPTION OF DRAWINGS

FIG. 1 is a perspective view of an illustrative embodiment of a stroller and attached support, with model, with cushioned, non-slip surface.

FIG. 2 is a perspective view of an illustrative embodiment of a stroller and attached support, with model, the support shown in an attached position on the lower front portion of the stroller affixed to the frame of the stroller.

FIG. 3 is a view of the support separate from the stroller and embodiment of connectors and a cushioned, non-slip surface.

FIG. 4 is a view of the support separate from the stroller showing the underside of the support with embodiment of connectors.

FIG. 5 is a view of the support separate from the stroller showing a side view of the support with perspective on the cushioned, non-slip surface of the support.

### DETAILED DESCRIPTION OF DRAWINGS

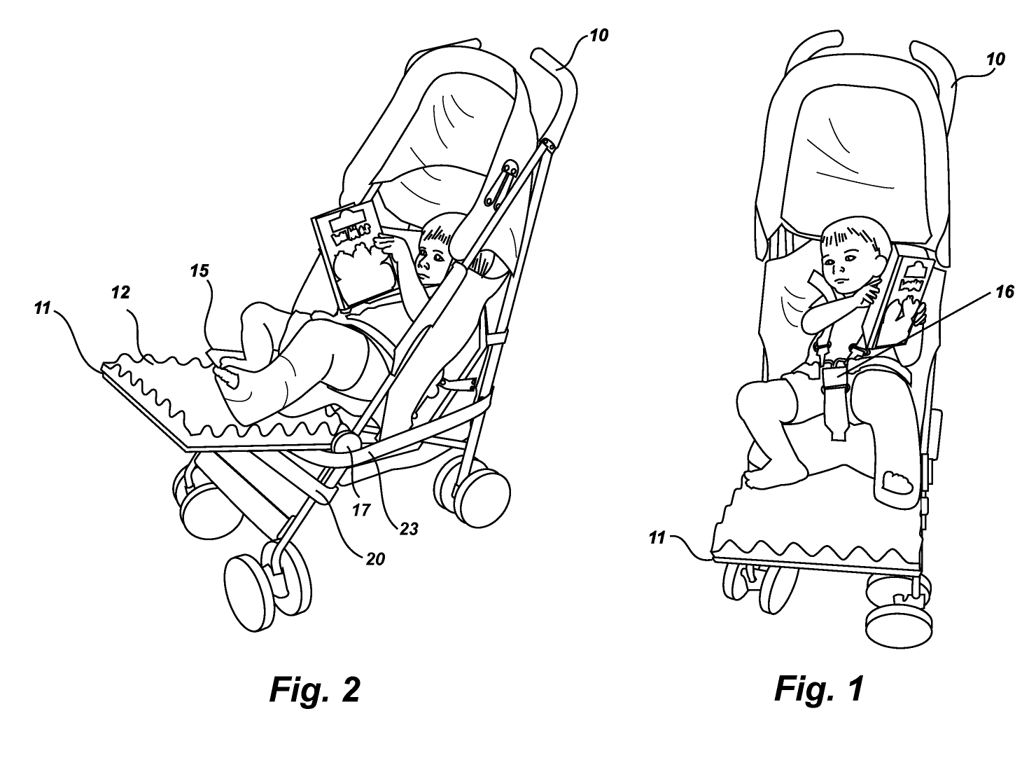

The perspective view of FIG. 1 shows a front view of a stroller frame 10 and support 11. The model is shown securely fastened by a standard three point harness 16 in the stroller. The utilization of this existing feature of the stroller reduces the risk that an already injured child will be further imperiled by an ejection from the stroller. The support 11 is of a similar width to the seat of the stroller and extends a distance beyond the edge of the stroller seat. The support 11 can be removed from the stroller once the child's injury has healed and there is no longer any need for leg support.

FIG. 2 shows a stroller frame 10 with the support 11 affixed to the frame of the stroller. The stroller frame 10 may be of any various constructions used for the purpose of self contained mobile transportation of a child. The support 11 may be used to support the legs of a child one or both of which may be in a foot, leg or spica cast or brace. The leg support 11 consists of a cushioned, non-slip surface 12 that minimizes movement of the child's cast. The cushioned, non-slip surface 12 provides comfort to and freedom of movement of the foot and or leg not in a cast while minimizing movement of a cast. Furthermore, the support 11 is easily used by a child with a leg brace or cast other than a Spica cast or Frejka pillow splint.

Two fasteners 20, 23 are shown and used to secure the support 11 to the stroller. In this embodiment the support 11 is attached to the downward front and rear tubes of the stroller frame 10. The support 11 may be attached to the stroller frame 10 by, straps, screws, glue, clips or any method that yields a secure connection between the stroller frame 10 and the support 11. A movable joint 17 is located on both sides of the support and abut the frame of the stroller 10, and can be adjusted to match the upper shelf of the support with the angle of the seat of the stroller 15. The movable joint 17 may be located anywhere on the support, and of any number, allowing the support to be adjusted to the angle of the seat of the stroller.

When there is no longer any need for the support 11 the support 11 may be removed by manually releasing the fasteners 20, 23, which, manually attached, holds the support 11 secured to the frame of the stroller 10.

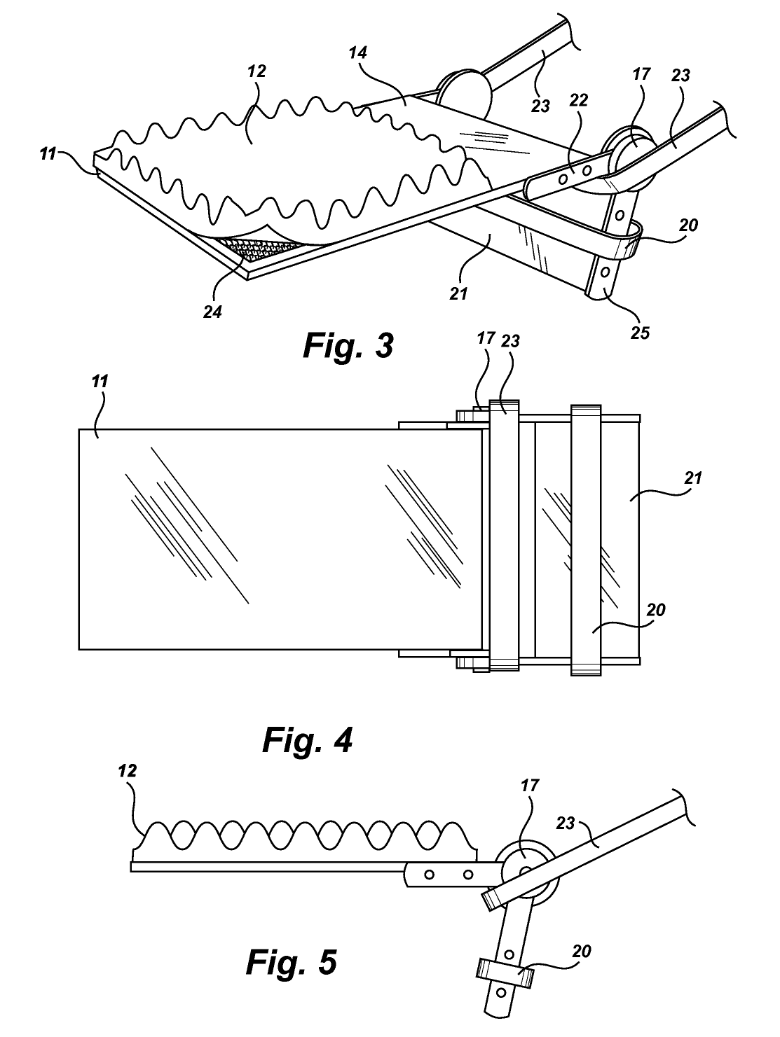

FIG. 3 shows a top view of the support 11 separate from the stroller frame. Fasteners 20, 23 are shown extending from both sides of the support 11. The lower fastener 20 affixes the lower shelf of the support 21 to the frame of the stroller. The upper fastener 23 is used to securely attach the top shelf 14 to the frame of the stroller and prevent the support from slipping off the frame from downward pressure applied to the top shelf of the support. Two arms 22, 25 extend from each movable joint 17 providing the connection of the lower 21 and upper 14 shelves to the movable joint 17. The cushioned, non-slip surface 12 may be replaced if worn-down and is detachable 24 from the top shelf. Because a cast adds weight to a child's leg, the support 11 is constructed in such a way as to support the added weight of a cast while extending a considerable distance beyond the seat of the stroller. The width of the top shelf 14 and the width of the lower shelf 21 fit the frames of most commercial strollers.

FIG. 4 shows a bottom view of the support 11 separate from the stroller frame. Fasteners 20, 23 firmly attach the support 11 to the stroller frame. The joints 17 are movable and may be set between 0° and 90° by disengaging a lock and moving the upper and lower shelves to the desired angle and reengaging the lock, the lock may be internal to or external of the joint itself. This allows the upper shelf to remain securely in place while the support is in use. The angle of the support 11 may be changed to support the leg once the cast is removed and the recovering leg must remain elevated. The movable joint 17 located on each side of the support, allows the support 11 to collapse and store when not in use.

FIG. 5 shows a side view of the support separate from the stroller. A foot or leg(s) in a cast rest comfortably and stable on the cushioned, non-slip surface 12. The movable joint 17 on each side of the support allows the support to be adjusted to fit various stroller seat angles. Fasteners 20, 23 firmly attach the support to the stroller frame.

The following list includes, but is not limited to, possible materials that may be used to construct this specific device: plastic, wood, fiberglass, carbon fiber, titanium, steel, copper, chrome, chrome-moly, aluminum, PVC, foam rubber, cloth, Kevlar, egg-crate foam, natural rubber, synthetic rubber, carpet. The support may be built in different ways to include, but not limited to, preassembled, preassembled and attached to a stroller, or may require assembly before attachment to a stroller (i.e. a kit).

The foregoing description of exemplary physical embodiments of the present invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

I claim:

1. A support apparatus for attachment to strollers of various sorts for supporting foot (feet) or leg(s) in a cast(s) or brace(s) of various sorts, the support comprising:
a combination of two shelves each comprising a lower portion, an upper portion, and adjustable connectors interconnecting the lower and upper portions;
a frame assembly comprising an upper arm, a lower arm, the upper arm affixed to a upper support shelf and a lower arm affixed to a lower support shelf constructed and arranged to engage the pivot mechanism(s) to adjust the lower support shelf toward the upper support shelf, forming an angle and allowing the upper support shelf to extend beyond the seat of the stroller;
wherein the support shelves form an area with longer sides and shorter sides, the longer sides of the cross sections of the upper shelf section extending beyond the seat of the stroller and the lower shelf section affixed to the stroller.
Wherein the support is constructed of a lightweight but firm materials that can provide support to a foot (feet) or leg(s) in a cast(s) or brace(s).
wherein the support is attached to the frame of a stroller by various fasteners.

2. A support apparatus, as defined in claim 1 made of material for attachment to a stroller having a frame and a three point harness, the support having a non-skid surface extends substantially beyond the seat of the stroller and affixes to the frame of the stroller, the support having a width and length sufficient to permit the child to rest his or her legs and feet upon the padded cushioned, non-slip surface, a fastener secures the bottom shelf to the frame of the stroller, the fastener is comprised of a material that provides secure and stable attachment to the frame of the stroller.
a fastener that affixes to the stroller in such a way as to allow the downward pressure of the foot/leg cast to be supported.
a fastener or fasteners that attach to the frame of the support and the frame of the stroller.
The fastening mechanisms are such that they attach securely to the frame of the stroller.
The angle of the support is changed by manipulating the angle of the arms on each side of the support and locking the arms of the support in place.

3. A support apparatus, as defined in claim 1 in which the support may be used for one model or different models of strollers.

4. A support apparatus, as defined in claim 1 for attachment to strollers of various sorts having a support shelf, a shelf designed to support a leg or foot in a cast, and able to lock at fixed angles, while affixed to the frame of a stroller.

5. A stroller that has such a support comprising:
a. a seat on which a baby or small child can fit.
b. A frame a seat attached to a frame with a set of wheels.
c. a removable support apparatus attached to a stroller having a support shelf, a cushioned, non-slip surface designed to support a leg, legs, foot or feet in a cast or brace, with movable locking joints.
d. A support apparatus usable with more than one type of stroller.
